(19) United States
(12) Patent Application Publication
(10) Pub. No.: US 2011/0153456 A1
(43) Pub. Date: Jun. 23, 2011

(54) Systems and Methods for Selecting Outfits

(76) Inventor: Christina Clay, Orange, CA (US)

(21) Appl. No.: 12/977,456

(22) Filed: Dec. 23, 2010

Related U.S. Application Data
(60) Provisional application No. 61/289,642, filed on Dec. 23, 2009.

(51) Int. Cl. G06Q 30/00; G06F 17/30

(52) U.S. Cl. 705/26.63; 707/769; 707/E17.016; 707/E17.109

(57) ABSTRACT

Systems and methods are described that select an outfit for a user from a database that stores a plurality of predefined outfits. A first interface can be used to obtain instructions from a user including at least a body shape and an event type. Using the instructions, a computer-based selector can select at least one predefined outfit that has at least two pieces, and the at least one predefined outfit can be displayed to the user via a second interface. Physical transfer of the at least one predefined outfit, or a portion thereof, can be facilitated by the systems and methods described herein.

This application claims the benefit of priority to U.S. provisional application having Ser. No. 61/289,642 filed on Dec. 23, 2009. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is systems and methods for assisting a user in finding outfits.

### BACKGROUND

Many websites and other user interfaces are known in which a user is presented with one or more items of clothing based upon one or more factors selected by the user. For example, a user might select a type of clothing such as pants, a size and a color, and then be presented with a list of pants matching those factors. Although such interfaces allow a user to more effectively browse a database of items, the interface fails to select a predefined outfit for the user. Instead, the user must herself navigate various lists of clothing to find items that can be worn together.

U.S. patent appl. no. 2009/0276291 to Wannier, et al. discusses methods in which a user is presented with a list of garments that is ranked based upon various parameters such as garment type, customer measurements, and garment measurements. Other filters can be applied to the list including styles and topics. The Wannier methods utilize these parameters and filters to assist in ranking a list of garments, but fail to contemplate selecting a predefined outfit (or more technically, selecting one or more images of a predefined outfit) to a user.

Wannier and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Websites are also known that present a user with additional products such as clothing and accessories after the user selects a first item of interest. See, e.g., U.S. Pat. No. 7,346,561. However, such websites also fail to contemplate selecting a predefined outfit to a user based upon instructions from a user including a body shape and event type.

Thus, there is still a need for systems and methods that can receive instructions from a user and present the user with one or more predefined outfits.

### SUMMARY OF THE INVENTION

The inventive subject matter provides apparatus, systems and methods in which instructions obtained from a user are used at least in part to select one or more predefined outfits for the user. As used herein, the term “outfit” means a collection of at least two pieces that are non-fungible equivalents, which can include articles of clothing and accessories. For example, non-fungible pieces might include a pair of pants and a shirt, or a blouse, a skirt and a pair of shoes, but would not include two pairs of pants. Contemplated articles of clothing could include for example, pants, skirts, shorts, shirts, blouses, dresses, jackets, and so forth. Contemplated accessories can include, for example, shoes, belts, purses, jewelry, hair pieces, and so forth.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

The pieces could be for-sale pieces or user-owned pieces. As used herein, the term “for-sale pieces” means pieces that are available for purchase by the user, and the term “user-owned pieces” means pieces that the user previously purchased or otherwise owns.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is diagram of an embodiment of a system configured to select an outfit for a user.

FIG. 2 is a flowchart of a method for selecting an outfit for a user.

### DETAILED DESCRIPTION

It should be noted that while the following description is drawn to a computer/server based outfit selection system, various alternative configurations are also deemed suitable and may employ various computing devices including servers, interfaces, systems, databases, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclose apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

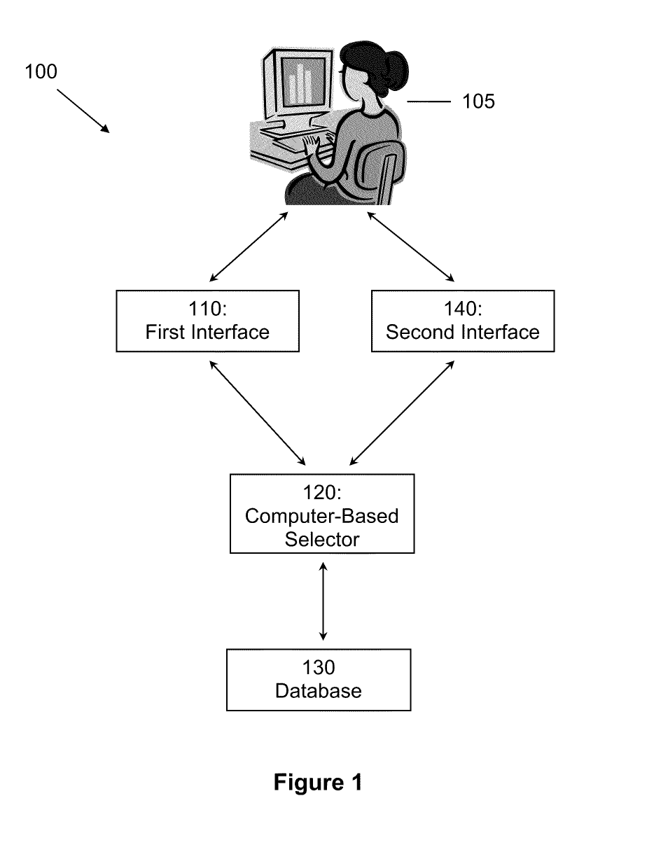

In FIG. 1, an embodiment of a system 100 is shown that is configured to select one or more predefined outfits for a user 105. The system 100 can include a first interface 110 configured to receive instructions from the user 105 including, for example, a body shape, a height, a weight, a waist size, a color preference, an event type, and any combination(s) thereof. For example, the first interface 110 could be part of a web page that allows the user 105 to input various instructions via a form or other data input method. The first interface 110 could also be a software application or any other commercially suitable interface or combination(s) thereof.

The system 100 can process the instructions using a computer-based selector 120 to thereby select at least one, and preferably at least two, predefined outfits for the user 105 from database 130. As used herein, the term “computer-based selector” includes at least an electronic processor and a memory that collectively operate with a software to present an outfit based at least in part from the instructions received. The selected predefined outfits can be displayed on a second interface 140, which might or might not be the same as the first interface 110.

Optionally, the system 100 can also present the user 105 with an image and/or video of a celebrity who is wearing the same or a similar outfit as the predefined outfit that the system 100 selected for the user 105. Preferably, the celebrity has a similar body shape to the user 105, such that the user 105 can obtain a better understanding about how the predefined outfit might fit the user's body prior to purchasing the predefined outfit. Alternatively, an image of a model having a similar body shape to the user 105 could be presented to the user 105.

In preferred embodiments, the user 105 can be provided with instructions concerning how to purchase each piece of the one or more predefined outfits. Such instructions could include, for example, a price of the piece and other information about the piece, a URL or other location information of an electronic (on-line) retailer, a physical address of a store, a telephone number, and any combination(s) thereof. It is contemplated that each piece could have the same or different instructions from the other piece(s) of the one or more predefined outfits. For example, a single outfit might include three pieces, two of which can be purchased from a first retailer, and one that can be purchased from a second retailer. The user 105 could be presented with information regarding how to purchase each of the pieces. It is also contemplated that one or more of the pieces could be available for purchase at multiple locations, and the system 100 could present the user 105 with all of the available locations for purchase.

Additionally or alternatively, the instructions could include a URL or other identifier that directs the user 105 to a shopping cart on a third party website that can be pre-populated with one or more pieces of the predefined outfit. This is advantageous as it allows the user 105 to conveniently purchase a portion of, or the entire outfit, by clicking the URL or other identifier. Thus, for example, a user 105 might click on a specific piece of the predefined outfit to purchase that piece, or click on the predefined outfit itself, a dedicated button, or other link to purchase the entire outfit. The user 105 could then be taken to one or more websites or shopping carts to purchase the piece(s) of the predefined outfit.

In other contemplated embodiments, a user 105 can store user-owned pieces on a server or other data storage medium, which can be accessed via the first 110 or second interface 140. In this manner, the user 105 can create an online closet of user-owned pieces that is accessible from anywhere. It is also contemplated that the system 100 could access the user's online closet while selecting outfits for the user 105 to wear, such that at least a portion of one outfit presented to the user 105 includes at least one user-owned piece. For example, an outfit might contain a shirt and a pair of pants not owned by the user 105, as well as a pair of shoes previously purchased by the user 105.

Optionally, the user 105 could allow some or all of the clothes and accessories in the user's online closet to be viewable by friends of the user 105, or others with whom the user 105 has connected. By allowing others to view the user's online closet, the user 105 is able to share clothing or accessories with other users, either by allowing another user to borrow a piece, or by trading a piece for something from the other user. For example, a user 105 might designate a pair of pants for trading purposes, and then the user 105 or another user could initiate a trade involving the pair of pants or other designated pieces. It is contemplated that the trading interface could be distinct from the first 110 and second interfaces 140, or could be the same interface as either the first 110 or second interfaces 140. It is further contemplated that the trading interface could track the trade, and notify the user 105 to whom an item was traded.

The user 105 might also be able to view a friend's closet to recommend what another user should wear to an event, or have another user recommend an outfit to the user 105. A user 105 could also designate some of the pieces in the user's online closet for trading purpose with other users.

It is further contemplated that the computer-based selector 120 could present an outfit to the user 105 that includes at least one piece that is not user-owned, but that is in an online closet of a user's friend or connection. For example, the outfit might contain two pieces in which the first piece is a for-sale piece, and the second piece is shared in an online closet of the user's friend.

The user-owned pieces in a user's online closet can be grouped by outfit, event type, or other practical groupings.

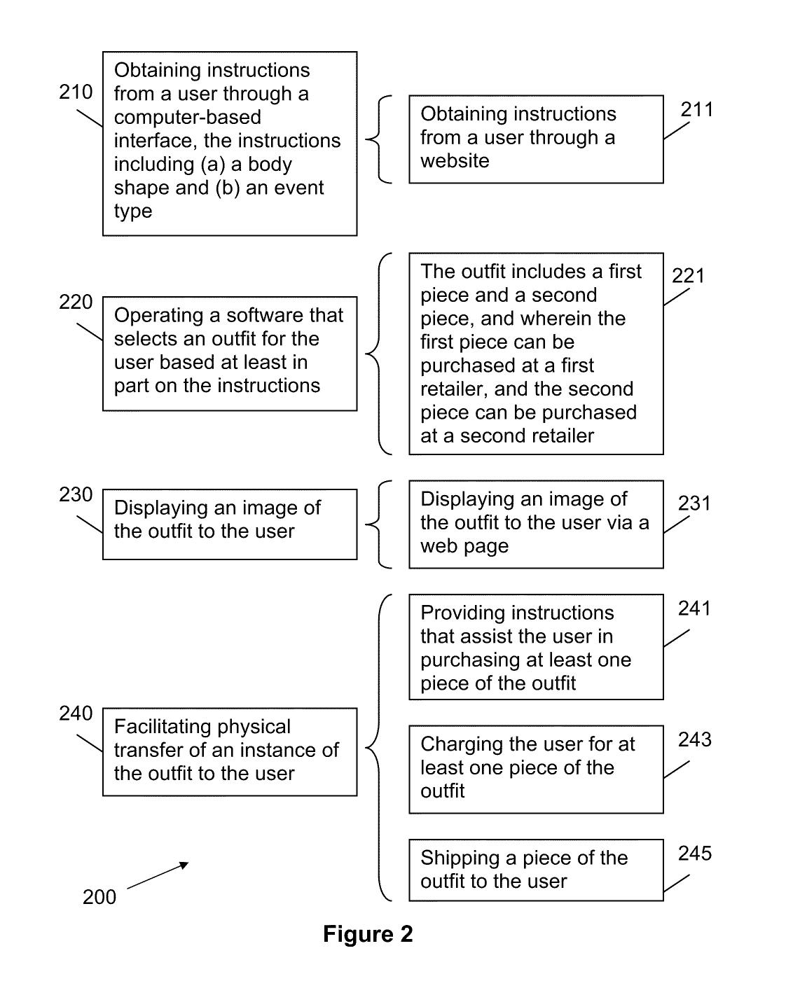

FIG. 2 presents one embodiment of a method 200 for selecting an outfit for a user. Step 210 can include obtaining instructions from a user through a computer-based interface, the instructions including (a) a body shape and (b) an event type. Preferably, in step 211, the instructions are obtained from the user via a webpage.

Step 220 can include operating software that selects a predefined outfit for the user based at least in part of the instructions obtained. Contemplated outfits include at least first and second pieces that are non-fungible. While the first and second pieces could be available for sale at a single retailer, it is contemplated in step 221 that the first piece could be purchased from a first retailer, and the second piece purchased from a second retailer that is a separate entity from the first retailer.

In step 230, an image of the predefined outfit can be displayed to the user. In step 231, the image can be displayed on a web page of a website, although the predefined outfit could be displayed on any commercially-suitable interface including, for example, in an email message to the user.

Step 240 can include facilitating physical transfer of an instance of the predefined outfit to the user. The step 240 of facilitating physical transfer of the predefined outfit to the user can include, for example, providing instructions that assist the user in purchasing at least one piece of the outfit in step 241, charging the user for at least one piece of the predefined outfit in step 243, shipping a piece of the predefined outfit to the user in step 245, and any combination(s) thereof. It is contemplated that the instructions could include the physical or electronic location where to purchase a piece of the predefined outfit, as well as a price of the predefined outfit, for example. The step 240 of facilitating physical transfer could be performed by the computer-based selector, although it is also contemplated that a distinct system from the computer-based system could perform this step 240.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system configured to select an outfit for a user, comprising:
a first interface that receives instructions from a user including a body shape and an event type;
a database that stores a plurality of predefined outfits, each of which have at least a first piece from a first vendor and a second piece from a second vendor unrelated to the first vendor;
a computer-based selector configured to select at least one of the predefined outfits based upon the instructions; and
a second interface that displays the at least one predefined outfit.

2. The system of claim 1, wherein the first interface comprises a web page.

3. The system of claim 1, wherein the second interface is the first interface.

4. The system of claim 1, wherein the computer-based selector selects a first predefined outfit comprising first and second pieces, and a second predefined outfit comprising third and fourth pieces, and wherein no two pieces of the first, second, third and fourth pieces are fungible equivalents.

5. The system of claim 1, wherein the at least one predefined outfit has at least five pieces.

6. The system of claim 5, wherein the at least five pieces comprises a pair of earrings, pants, shoes, top, and at least one of a belt and a handbag.

7. The system of claim 1, further comprising a database for storing at least one user-owned piece.

8. The system of claim 7, wherein the at least one predefined outfit is based at least in part on the at least one user-owned piece.

9. The system of claim 1, wherein the at least two pieces comprise for-sale pieces.

10. A method for selecting an outfit for a user, comprising:
obtaining instructions from a user through a computer-based interface, the instructions including (a) a body shape and (b) an event type;
operating a software that selects a predefined outfit for the user based upon the instructions obtained;
displaying an image of the predefined outfit to the user; and
facilitating physical transfer of an instance of the predefined outfit to the user.

11. The method of claim 10, wherein the predefined outfit includes a first piece and a second piece, and wherein the first piece can be purchased at a first retailer, and the second piece can be purchased at a second retailer that is different from the first retailer.

12. The method of claim 10, further comprising obtaining the instructions from the user via a website.

13. The method of claim 10, further comprising obtaining the instructions from the user via a software application.

14. The method of claim 10, further comprising displaying the image of the predefined outfit via a website.

15. The method of claim 10, wherein the step of facilitating physical transfer includes providing instructions that assist the user in purchasing at least one piece of the predefined outfit.

16. The method of claim 10, wherein the step of facilitating physical transfer further comprises providing a hyperlink to the user that directs a user to a website of a first retailer.

17. The method of claim 10, wherein the step of facilitating physical transfer includes charging the user for at least one piece of the predefined outfit.

18. The method of claim 10, wherein the step of facilitating physical transfer includes shipping a piece of the predefined outfit to the user.
